(19) United States
(12) Patent Application Publication
(10) Pub. No.: US 2025/0233906 A1
(43) Pub. Date: Jul. 17, 2025

(54) MEDIA STREAM TRANSMISSION METHOD AND APPARATUS, ELECTRONIC DEVICE, AND STORAGE MEDIUM

(71) Applicant: Douyin Vision Co., Ltd., Beijing (CN)

(72) Inventors: Huisheng HUANG, Beijing (CN); Wei ZHANG, Beijing (CN); Wei WANG, Beijing (CN); Hang FU, Beijing (CN)

(21) Appl. No.: 19/170,966

(22) Filed: Apr. 4, 2025

Related U.S. Application Data
(63) Continuation of application No. PCT/CN2023/133633, filed on Nov. 23, 2023.

(30) Foreign Application Priority Data
Jan. 12, 2023 (CN) 202310064072.1

(51) Int. Cl. H04L 65/80; H04L 67/1001

(52) U.S. Cl. CPC H04L 65/80; H04L 67/1001

(57) ABSTRACT

The media stream transmission method includes: receiving a first request for media data from a first terminal; determining a second request according to downlink information and transmitting the second request to a second terminal; where the downlink information is configured to indicate request load information and/or downlink network quality-of-service information, the request load information represents a quantity and/or frequency of a plurality of third requests received within a preset time period, and the plurality of third requests include the first request; receiving, from the second terminal, a first media data message being a response to the second request; where the first media data message includes a first media stream; and transmitting, to the first terminal, a second media data message being a response to the first request, where the second media data message includes a second media stream, and the first media stream includes the second media stream.

### CROSS-REFERENCE TO RELATED APPLICATIONS

This application is a continuation of International Application No. PCT/CN2023/133633, as filed on Nov. 23, 2023, which is based on and claims priority to Chinese Patent Application No. 202310064072.1, filed on Jan. 12, 2023. The disclosures of each of these applications are incorporated herein by reference in their entireties.

### TECHNICAL FIELD

The present disclosure relates to the technical field of communication. More specifically, the present disclosure relates to a media stream transmission method and apparatus, an electronic device, and a storage medium.

### BACKGROUND

During the process of multi-person real-time communication, it is necessary to transmit media streams, such as audio streams and/or video streams. In this field, the protocol generally used for multi-person real-time communication is RTP (Real-time Transport Protocol). RTP often needs to be implemented based on RTCP (RTP Control Protocol). Although the related technologies can use RTP to achieve the function of multi-person real-time communication, the specific communication process using RTCP needs to be implemented based on UDP (User Datagram Protocol). However, UDP is an unreliable transmission protocol, and packet loss problems are very likely to occur. To improve the reliability of real-time communication, the related technologies need to rely on the media data publisher to provide undifferentiated feedback for all received media data requests. When the number of media data requests is large, the request load on the media data publisher is relatively high, resulting in problems such as overly slow or no response to media data requests. For users, slow or no response to media data requests will directly lead to a poor experience during the real-time communication process.

### SUMMARY

In order to solve the problem in the related art that the slow or no response to media data requests leads to a poor experience during the real-time communication process, the present disclosure provides a media stream transmission method and apparatus, an electronic device, and a storage medium, aiming to improve the response rate for media data requests and enhance the real-time communication experience, among other purposes.

In order to solve one or more problems existing in the prior art, the present disclosure provides a media stream transmission method, which is applied to a media server. The media stream transmission method includes: receiving a first request for media data from a first terminal; determining a second request according to downlink information and transmitting the second request to a second terminal; where the downlink information is configured to indicate request load information and/or downlink network quality-of-service information, the request load information represents a quantity and/or frequency of a plurality of third requests received within a preset time period, and the plurality of third requests include the first request; receiving, from the second terminal, a first media data message being a response to the second request; where the first media data message includes a first media stream; and transmitting, to the first terminal, a second media data message being a response to the first request, where the second media data message includes a second media stream, and the first media stream includes the second media stream.

In order to solve one or more problems existing in the prior art, the present disclosure provides a media stream transmission method, which is applied to a first terminal. The method includes: transmitting a first request for media data to a media server; where the media server is configured to determine a second request according to downlink information and to transmit the second request to a second terminal; the downlink information is configured to indicate request load information and/or downlink network quality-of-service information, the request load information represents a quantity and/or frequency of a plurality of third requests received within a preset time period, and the plurality of third requests include the first request; the media server is configured to receive, from the second terminal, a first media data message being a response to the second request; and the first media data message includes a first media stream; and receiving, from the media server, a second media data message being a response to the first request, where the second media data message includes a second media stream, and the first media stream includes the second media stream.

In order to solve one or more problems existing in the prior art, the present disclosure provides a media stream transmission method, which is applied to a second terminal. The method includes: receiving a second request from a media server, where the media server is configured to receive a first request for media data from a first terminal and to determine the second request according to downlink information, the downlink information is configured to indicate request load information and/or downlink network quality-of-service information, the request load information represents a quantity and/or frequency of a plurality of third requests received within a preset time period, and the plurality of third requests include the first request; and transmitting, to the media server, a first media data message being a response to the second request; where the first media data message includes a first media stream, the media server is configured to transmit, to the first terminal, a second media data message being a response to the first request, the second media data message includes a second media stream, and the first media stream includes the second media stream.

In order to solve one or more problems existing in the prior art, the present disclosure can also provide a media stream transmission apparatus, including:

A first request receiving module, configured to receive a first request for media data from a first terminal.

A first request transmitting module, configured to determine a second request according to downlink information and to transmit the second request to a second terminal; where the downlink information is configured to indicate request load information and/or downlink network quality-of-service information, the request load information represents a quantity and/or frequency of a plurality of third requests received within a preset time period, and the plurality of third requests include the first request.

A first message receiving module, configured to receive, from the second terminal, a first media data message being a response to the second request; where the first media data message includes a first media stream.

A first message transmitting module, configured to transmit, to the first terminal, a second media data message being a response to the first request, where the second media data message includes a second media stream, and the first media stream includes the second media stream.

In order to solve one or more problems existing in the prior art, the present disclosure can also provide a media stream transmission apparatus, including:

A second request transmitting module, configured to transmit a first request for media data to a media server; where the media server is configured to transmit a first request for media data to a media server; where the media server is configured to determine a second request according to downlink information and to transmit the second request to a second terminal; the downlink information is configured to indicate request load information and/or downlink network quality-of-service information, the request load information represents a quantity and/or frequency of a plurality of third requests received within a preset time period, and the plurality of third requests include the first request; the media server is configured to receive, from the second terminal, a first media data message being a response to the second request; and the first media data message includes a first media stream.

A second message receiving module, configured to receive, from the media server, a second media data message being a response to the first request, where the second media data message includes a second media stream, and the first media stream includes the second media stream.

In order to solve one or more problems existing in the prior art, the present disclosure can also provide a media stream transmission apparatus, including:

A second request receiving module, configured to receive a second request from a media server, where the media server is configured to receive a first request for media data from a first terminal and to determine the second request according to downlink information, the downlink information is configured to indicate request load information and/or downlink network quality-of-service information, the request load information represents a quantity and/or frequency of a plurality of third requests received within a preset time period, and the plurality of third requests include the first request.

A second message transmitting module, configured to transmit, to the media server, a first media data message being a response to the second request; where the first media data message includes a first media stream, the media server is configured to transmit, to the first terminal, a second media data message being a response to the first request, the second media data message includes a second media stream, and the first media stream includes the second media stream.

In order to solve one or more problems existing in the prior art, the present disclosure can also provide an electronic device, including a memory and a processor. Computer-readable instructions are stored in the memory, and the computer-readable instructions, when being executed by the processor, cause the processor to perform the media stream transmission method in any embodiment of the present disclosure.

In order to solve one or more problems existing in the prior art, the present disclosure can also provide a storage medium storing computer-readable instructions. The computer-readable instructions, when being executed by one or more processors, cause the one or more processors to perform the media stream transmission method in any embodiment of the present disclosure.

The beneficial effects of the present disclosure include: in the embodiment of the present disclosure, a first terminal for requesting media data transmits a first request to a media server, then the media server determines a second request to be transmitted to a second terminal according to downlink information. The second terminal transmits a first media data message including a first media stream in response to the second request to the media server, and the media server transmits a second media data message including a second media stream in response to the first request to the first terminal, where the first media stream includes the second media stream. The embodiments of the present disclosure, by virtue of the more powerful data processing capability of the media server, realize the transfer of all requests for media data originally borne by the second terminal to the media server for processing. Thus, the media server can feed back to the second terminal requests that the second terminal can bear and respond to quickly according to the actual situation of the request load and network service quality. Therefore, the present disclosure can meet the requirement of a quick response to media data requests during the real-time communication process, avoid problems such as no response caused by downlink congestion or poor network service quality to the greatest extent, and significantly improve the user experience during the real-time communication process, especially enhancing the experience of each user during the multi-person real-time communication process.

### BRIEF DESCRIPTION OF THE DRAWINGS

FIG. 1 shows a schematic flowchart of the media stream transmission method in one or more embodiments of the present disclosure.

FIG. 2 shows a schematic flowchart of updating the first request to the second request in one or more embodiments of the present disclosure.

FIG. 3 shows a schematic flowchart of taking any one of the plurality of same first requests as the second request in one or more embodiments of the present disclosure.

FIG. 4 shows a schematic flowchart of determining the second request based on the request frequency in one or more embodiments of the present disclosure.

FIG. 5 shows a schematic flowchart of transmitting the second media data message to the first terminal in one or more embodiments of the present disclosure.

FIG. 6 shows a schematic diagram of the working principle of the first terminal requesting the media stream from the second terminal through the media server in one or more embodiments of the present disclosure.

FIG. 7 shows a schematic diagram of one structural composition of the media stream transmission apparatus in one or more embodiments of the present disclosure.

FIG. 8 shows a schematic diagram of another structural composition of the media stream transmission apparatus in one or more embodiments of the present disclosure.

FIG. 9 shows a schematic diagram of yet another structural composition of the media stream transmission apparatus in one or more embodiments of the present disclosure.

FIG. 10 shows a schematic diagram of the internal structural composition of the electronic device in one or more embodiments of the present disclosure.

### DETAILED DESCRIPTION OF EMBODIMENTS

For those skilled in the art, the commonly used multi-person real-time communication protocol in the industry is RTP. However, this communication protocol is prone to packet loss problems, and the reliability of real-time communication is difficult to guarantee. Especially when the volume of data requests surges, the packet loss problem becomes extremely severe. In the specific real-time communication architecture, the related technologies overly rely on the media data publisher to provide undifferentiated feedback for the media data requests transmitted by respective media data subscribers. When the volume of media data requests is small, it generally does not affect the user experience. However, once the volume of media data requests surges and there are a large number of users engaged in real-time communication simultaneously, problems such as slow or no response to media data requests will occur in the related technologies, resulting in a poor real-time communication experience for multiple users.

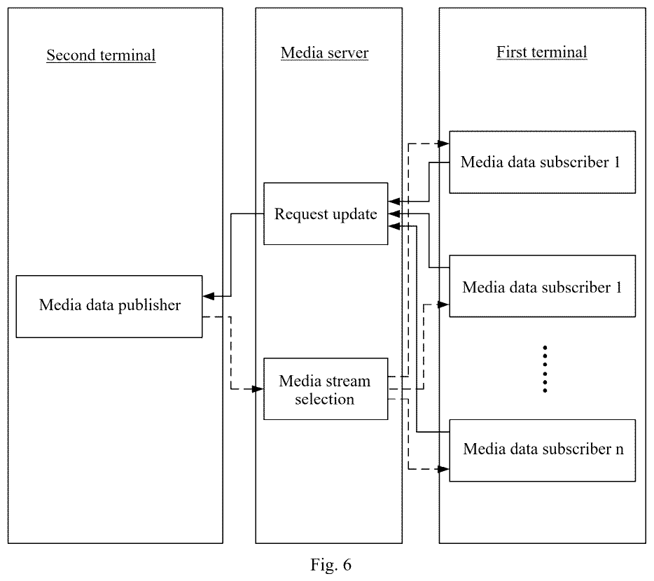

As shown in FIG. 6, in the real-time communication scenario, the embodiment of the present disclosure sets up a media server, which is configured to connect to respective clients. The client is specifically a media data subscriber (or a media data subscribing end) shown in the figure. In this embodiment, a multi-person real-time communication architecture is formed through a first terminal, the media server, and a second terminal. The first terminal includes media data subscriber 1, media data subscriber 2, . . . , media data subscriber n, where n represents the number of media data subscribers in this embodiment. The second terminal is specifically a media data publisher (or a media data publishing end). The media server is respectively connected to the first terminal and the second terminal. A real-time communication link between the first terminal and the media server serves as a downlink, and a real-time communication link between the media server and the second terminal serves as an uplink. The media server in the embodiment of the present disclosure not only plays the roles of relaying and forwarding, but also plays the roles of filtering, screening, and aggregating data requests, and performing the optimal stream selection on the received media streams. Next, respective embodiments of the present disclosure will be described in detail.

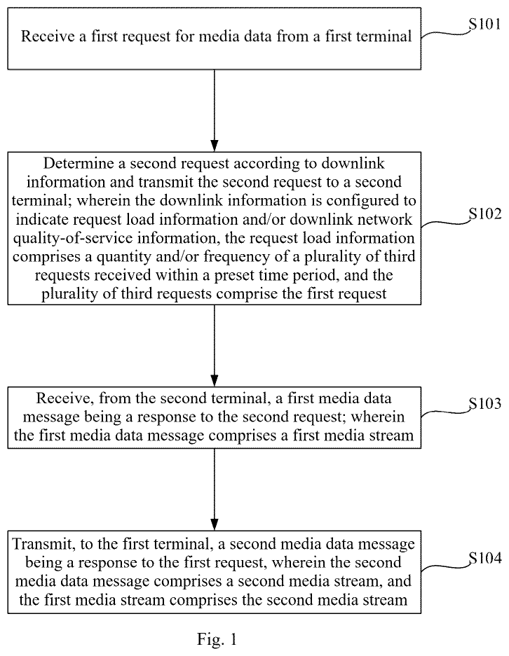

As shown in FIG. 1, one or more embodiments of the present disclosure provide a media stream transmission method, which is applied to a media server, and can be specifically applied to a media server for realizing real-time communication. In this embodiment, the media stream transmission method may include, but is not limited to, steps S101 to S104.

Step S101: Receive a first request for media data from a first terminal.

The first request in this embodiment refers to a media data request transmitted by the first terminal to the media server.

In at least one embodiment of the present disclosure, receiving a first request for media data from the first terminal includes: receiving the first request for media data from the first terminal based on a peer-to-peer data channel of web real-time communication.

The preset media channel in the embodiment of the present disclosure may specifically be a peer-to-peer data channel (Datachannel) based on web real-time communication (WebRTC). In this embodiment, the Datachannel can achieve more reliable communication and data transmission, reduce the packet loss rate, and improve the real-time communication effect, especially the effect of multi-person real-time communication. For example, in the real-time communication process involving hundreds of people or more (such as in a video conference scenario), it can enhance the real-time communication experience of each user. The communication method based on the Datachannel in the embodiment of the present disclosure has better compatibility, is convenient for use on different operating system platforms, and achieves the purpose of being universal across all platforms or the like. Therefore, the maintenance difficulty of the real-time communication architecture in this embodiment is lower, and the cost is reduced.

Step S102: Determine a second request according to downlink information and transmit the second request to a second terminal; where the downlink information is configured to indicate request load information and/or downlink network quality-of-service information, the request load information represents a quantity and/or frequency of a plurality of third requests received within a preset time period, and the plurality of third requests include the first request.

The request load information and/or downlink network quality-of-service information includes three situations: the request load information, the downlink network quality-of-service information, and, the request load information and the downlink network quality-of-service information. The quantity and/or frequency includes three situations: the quantity, the frequency, and, the quantity and the frequency.

The downlink information in the embodiment of the present disclosure is the result of the media server's perception of the downlink status, and in the real-time communication process, it realizes the media server's perception of the link status between a large number of first terminals and the media server.

The downlink network quality-of-service information in the embodiment of the present disclosure refers to information indicating that the network QoS (Quality of Service) between one or more media data subscribers and the media server deteriorates and it is difficult to meet the original media data transmission requirements.

Step S103: Receive, from the second terminal, a first media data message being a response to the second request; where the first media data message includes a first media stream.

In this embodiment, the first media data message specifically refers to the content responded to by the second terminal to the media server. The first media stream can be video and/or audio, etc., and the video and/or audio transmitted in a streaming manner can be called a code stream.

As shown in FIG. 6, in at least one embodiment of the present disclosure, the first terminal includes one or more media data subscribers, and the second terminal is the media data publisher. Based on the first media stream provided by the media data publisher, the present disclosure can be used for real-time communication of multiple media data subscribers.

Step S104: Transmit, to the first terminal, a second media data message being a response to the first request, where the second media data message includes a second media stream, and the first media stream includes the second media stream.

In one or more embodiments of the present disclosure, determining a second request according to the downlink information includes: updating the first request to the second request or determining the second request based on the plurality of third requests, according to the downlink information. It can be seen that based on the downlink information, the present disclosure includes two implementation situations: one is updating the first request to the second request, and the other is determining the second request based on the plurality of third requests. Thus, the above embodiments of the present disclosure can determine the second request according to the situation of the received first request or the situation of the plurality of third requests received within the preset time period, and transmit it to the second terminal. The present disclosure can further alleviate the request load borne by the second terminal through the method of request update or re-determination, improve the response effectiveness of the second terminal to media data requests, and thus improve the reliability of real-time communication.

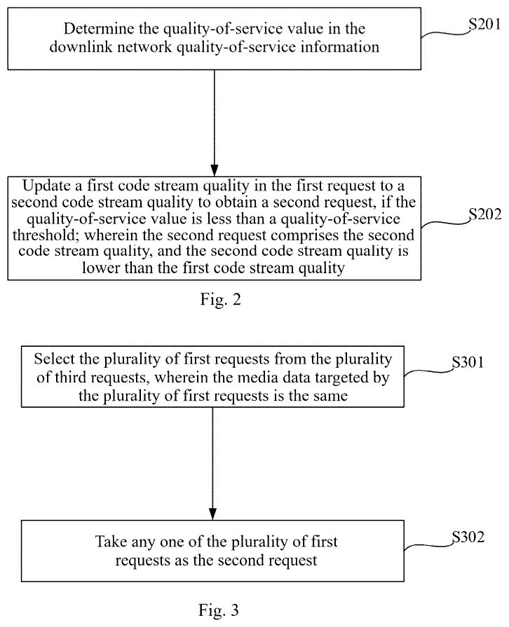

As shown in FIG. 2, in one or more embodiments of the present disclosure, the downlink network quality-of-service information includes a quality-of-service value; and the updating the first request to the second request includes, but is not limited to, steps S201 and S202.

Step S201: Determine the quality-of-service value (i.e., the QoS value) in the downlink network quality-of-service information.

The method for determining the QoS value can be selected from the related technologies, and this embodiment will not elaborate further.

Step S202: Update a first code stream quality in the first request to a second code stream quality to obtain a second request, if the quality-of-service value is less than a quality-of-service threshold; where the second request includes the second code stream quality, and the second code stream quality is lower than the first code stream quality.

If the quality-of-service value is greater than or equal to the quality-of-service threshold, in this embodiment, the first code stream quality in the first request will not be updated, and the first request can be directly taken as the second request, with a relatively high response effectiveness.

The above embodiment of the present disclosure achieves the purpose of identifying the network QoS and modifying the code stream quality in the media data request according to the low communication quality situation by the media server. Thus, in the case where the first terminal fails to successfully obtain the media stream with high code stream quality responded by the second terminal, the process of the first terminal transmitting a media data request again according to the network QoS is omitted. It can be seen that this embodiment significantly reduces the number of requests transmitted, avoids frequent communication processes, and reduces the request load of the second terminal.

As shown in FIG. 3, in one or more embodiments of the present disclosure, the plurality of third requests include a plurality of first requests for requesting the same media data, and determining the second request based on the plurality of third requests includes, but is not limited to, steps S301 to S302.

Step S301: Select (or screen) the plurality of first requests from the plurality of third requests, where the media data targeted by the plurality of first requests is the same.

The media server in the embodiment of the present disclosure can parse the above-mentioned plurality of third requests and select the plurality of first requests according to the parsing result.

Step S302: Take any one of the plurality of first requests as the second request.

The above embodiment of the present disclosure realizes the function of merging multiple first requests by selecting the plurality of first requests for requesting the same media data from the plurality of third requests and taking any one of the first requests as the second request. Compared with the method of transmitting all the plurality of first requests for requesting the same media data to the second terminal, the present disclosure effectively reduces the number of requests received by the second terminal and improves the response efficiency of the second terminal.

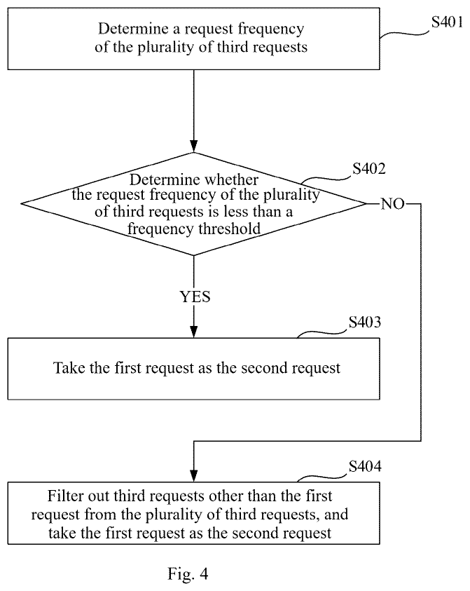

As shown in FIG. 4, in one or more embodiments of the present disclosure, the determining the second request based on the plurality of third requests includes, but is not limited to, steps S401 to S404.

Step S401: Determine a request frequency of the plurality of third requests.

For all the media data subscribers communicating with the media server, the media server in this embodiment can be configured to count the request frequency of the plurality of third requests received within the preset time period.

Step S402: Determine whether the request frequency of the plurality of third requests is less than a frequency threshold. The frequency threshold can be reasonably set according to the performance of the media server.

Step S403: Take the first request as the second request, if the request frequency of the plurality of third requests is less than the frequency threshold. When the request frequency is not high, the first request can be directly forwarded to the second terminal, which usually will not have an impact on the second terminal.

Step S404: Filter out third requests other than the first request from the plurality of third requests, and take the first request as the second request, if the request frequency of the plurality of third requests is greater than or equal to the frequency threshold.

Thus, in this embodiment, when the request frequency is high, some third requests can be filtered out to effectively reduce the media stream publishing frequency of the second terminal in the multi-person real-time communication scenario, avoid the problem of the second terminal malfunction caused by an excessively high media stream publishing frequency, and at the same time, take into account the comprehensive experience of most users according to the actual situation in the communication process, and prevent the problem of sacrificing the experience of most users due to individual users.

It should be understood that the present disclosure can use any two or all three of the methods for processing the first request shown in FIG. 2, FIG. 3, and FIG. 4. Certainly, on the basis of the content already provided in the present disclosure, this embodiment can also adopt other methods to process a large number of media data requests, as long as it can reduce or optimize the number of requests received by the second terminal.

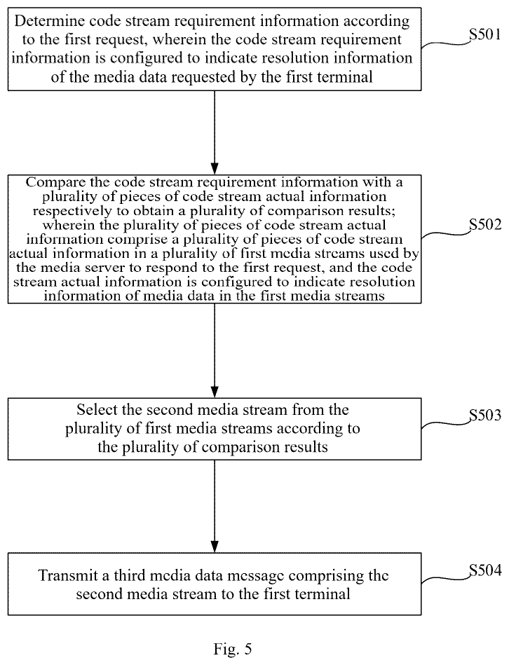

As shown in FIG. 5, in one or more embodiments of the present disclosure, the transmitting the second media data message to the first terminal includes, but is not limited to, steps S501 to S504.

Step S501: Determine code stream requirement information according to the first request, where the code stream requirement information is configured to indicate resolution information of the media data requested by the first terminal.

In this embodiment, the code stream requirement information can be parsed out by parsing the first request. Taking a video as an example, the code stream requirement information is, for example, 4K resolution information, 1080P resolution information, 720P resolution information, or the like.

Step S502: Compare the code stream requirement information with a plurality of pieces of code stream actual information respectively to obtain a plurality of comparison results; where the plurality of pieces of code stream actual information represent a plurality of pieces of code stream actual information in a plurality of first media streams used by the media server to respond to the first request, and the code stream actual information is configured to indicate resolution information of media data in the first media streams.

After comparing the plurality of pieces of code stream actual information with the code stream requirement information, a plurality of comparison results are obtained. For example, if the code stream requirement information is 720P resolution information, and the plurality of pieces of code stream actual information include 4K resolution information, 1080P resolution information, 720P resolution information, 360P resolution information, and 240P resolution information, etc., then the plurality of comparison results include the comparison result between 720P resolution information and 4K resolution information, the comparison result between 720P resolution information and 1080P resolution information, the comparison result between 720P resolution information and 720P resolution information, the comparison result between 720P resolution information and 360P resolution information, the comparison result between 720P resolution information and 240P resolution information, etc.

Step S503: Select the second media stream from the plurality of first media streams according to the plurality of comparison results.

In this embodiment, the comparison result that best meets the actual requirement is selected from the plurality of comparison results, including the comparison result where the code stream requirement information is the same as the code stream actual information, for example, the comparison result between 720P resolution information and 720P resolution information. Then, the corresponding first media stream is selected as the second media stream by using the comparison result that best meets the actual requirement. The second media stream in this embodiment can be understood as an optimal code stream, that is, the code stream that best meets the actual code stream requirement.

Step S504: Transmit a third media data message including the second media stream to the first terminal.

Combined with the above example, the optimal code stream in the embodiment of the present disclosure can be, for example, the code stream corresponding to the 720P resolution information.

In the above embodiment of the present disclosure, the code stream requirement information is determined based on the received first request, and the code stream actual information is determined based on the received first media streams, and the second media stream, which is the optimal code stream, is published to the first terminal based on the comparison result between the code stream requirement information and the code stream actual information. It can be seen that this embodiment takes into account the information related to both the downlink and the uplink (the link between the media server and the second terminal), realizes an information feedback mode for the entire link, achieves multi-terminal collaboration among the first terminal, the media server, and the second terminal, provides the optimal code stream for the first terminal, significantly improves the quality of real-time communication, and enhances the user experience during the real-time communication process.

In one or more embodiments of the present disclosure, the selecting the second media stream from the plurality of first media streams according to the plurality of comparison results includes: taking the first media stream corresponding to target code stream information as the second media stream, if the plurality of comparison results include that the code stream requirement information is the same as the target code stream information; where the target code stream information is one of the plurality of pieces of code stream actual information in the plurality of first media streams.

The first media stream corresponding to the target code stream information is the second media stream to be selected in this embodiment.

Based on the fact that the code stream requirement information is the same as the target code stream information, it indicates that there is an optimal code stream in the published media stream for responding to the media data request, and this method can accurately respond to the media data request through the optimal code stream.

In one or more embodiments of the present disclosure, the selecting the second media stream from the plurality of first media streams according to the plurality of comparison results includes: updating the code stream requirement information to code stream downgrade information, if all of the plurality of comparison results indicate that the code stream requirement information is different from target code stream information; where the code stream downgrade information is configured to indicate the code stream requirement information after the resolution is lowered, that is, the code stream quality requirement in the original code stream requirement information is lowered, and the target code stream information is one of the plurality of pieces of code stream actual information in the plurality of first media streams; and matching the code stream downgrade information with the plurality of pieces of code stream actual information in the plurality of first media streams, and selecting the first media stream corresponding to the code stream actual information that matches the code stream downgrade information as the second media stream, if the matching is successful.

Based on the above improved technical solution, the present disclosure can also achieve a faster response to the first request by reducing the code stream quality requirement, greatly improving the response efficiency.

The media stream transmission method provided in at least one embodiment of the present disclosure may further include: transmitting a fourth request to the second terminal, if the code stream downgrade information fails to match with any one of the plurality of pieces of code stream actual information in the plurality of first media streams, where the fourth request is configured to notify the second terminal to publish new media data with a preset resolution for responding to the first request.

From this, it can be seen that the present disclosure can also provide a strategy for requesting the media stream again. That is, in this embodiment, when the currently received media streams cannot meet the code stream requirement information after the code stream quality requirement is reduced, a request for new media data is transmitted to the second terminal, and the new media data can be configured to respond to the first request transmitted by the first terminal, thereby effectively improving the reliability of responding to the media data request.

Some embodiments of the present disclosure also provide a media stream transmission method, which is applied to the first terminal. The method includes: transmitting a first request for media data to a media server; where the media server is configured to determine a second request according to downlink information and to transmit the second request to a second terminal; the downlink information is configured to indicate request load information and/or downlink network quality-of-service information, the request load information represents a quantity and/or frequency of a plurality of third requests received within a preset time period, and the plurality of third requests include the first request; the media server is configured to receive, from the second terminal, a first media data message being a response to the second request; and the first media data message includes a first media stream; and receiving, from the media server, a second media data message being a response to the first request, where the second media data message includes a second media stream, and the first media stream includes the second media stream.

Optionally, the media server is configured to update the first request to the second request or determine the second request based on the plurality of third requests, according to the downlink information.

Optionally, the downlink network quality-of-service information includes a quality-of-service value; and the media server is configured to update a first code stream quality in the first request to a second code stream quality to obtain a second request, if the quality-of-service value is less than a quality-of-service threshold; where the second request includes the second code stream quality, and the second code stream quality is lower than the first code stream quality.

Optionally, the plurality of third requests include a plurality of first requests for requesting the same media data, and the media server is configured to select the plurality of first requests from the plurality of third requests, where the media data targeted by the plurality of first requests is the same; and the media server is configured to take any one of the plurality of first requests as the second request.

Optionally, the media server is configured to take the first request as the second request, if a request frequency of the plurality of third requests is less than a frequency threshold; and filter out third requests other than the first request from the plurality of third requests, and take the first request as the second request, if the request frequency of the plurality of third requests is greater than or equal to the frequency threshold.

Optionally, the media server is configured to determine code stream requirement information according to the first request, where the code stream requirement information is configured to indicate resolution information of the media data requested by the first terminal; the media server is configured to compare the code stream requirement information with a plurality of pieces of code stream actual information respectively to obtain a plurality of comparison results; where the plurality of pieces of code stream actual information represent a plurality of pieces of code stream actual information in a plurality of first media streams used by the media server to respond to the first request, and the code stream actual information is configured to indicate resolution information of media data in the first media streams; the media server is configured to select the second media stream from the plurality of first media streams according to the plurality of comparison results; and the media server is configured to transmit a third media data message including the second media stream to the first terminal.

Optionally, the media server is configured to take the first media stream corresponding to target code stream information as the second media stream, if the plurality of comparison results include that the code stream requirement information is the same as the target code stream information; where the target code stream information is one of the plurality of pieces of code stream actual information in the plurality of first media streams.

Optionally, the media server is configured to update the code stream requirement information to code stream downgrade information, if all of the plurality of comparison results indicate that the code stream requirement information is different from target code stream information; where the code stream downgrade information is configured to indicate the code stream requirement information after the resolution is lowered, and the target code stream information is one of the plurality of pieces of code stream actual information in the plurality of first media streams; and the media server is configured to match the code stream downgrade information with the plurality of pieces of code stream actual information in the plurality of first media streams, and select the first media stream corresponding to the code stream actual information that matches the code stream downgrade information as the second media stream, if the matching is successful.

Optionally, the media server is configured to transmit a fourth request to the second terminal, if the code stream downgrade information fails to match with any one of the plurality of pieces of code stream actual information in the plurality of first media streams, where the fourth request is configured to notify the second terminal to publish new media data with a preset resolution for responding to the first request.

Optionally, the media server is configured to receive the first request for media data from the first terminal based on a peer-to-peer data channel of web real-time communication.

Optionally, the first terminal is a media data subscriber, and the second terminal is a media data publisher.

Some other embodiments of the present disclosure also provide a media stream transmission method, which is applied to the second terminal. The method includes: receiving a second request from a media server, where the media server is configured to receive a first request for media data from a first terminal and to determine the second request according to downlink information, the downlink information is configured to indicate request load information and/or downlink network quality-of-service information, the request load information represents a quantity and/or frequency of a plurality of third requests received within a preset time period, and the plurality of third requests include the first request; and transmitting, to the media server, a first media data message being a response to the second request; where the first media data message includes a first media stream, the media server is configured to transmit, to the first terminal, a second media data message being a response to the first request, the second media data message includes a second media stream, and the first media stream includes the second media stream.

Optionally, the media server is configured to update the first request to the second request or determine the second request based on the plurality of third requests, according to the downlink information.

Optionally, the downlink network quality-of-service information includes a quality-of-service value; and the media server is configured to update a first code stream quality in the first request to a second code stream quality to obtain a second request, if the quality-of-service value is less than a quality-of-service threshold; where the second request includes the second code stream quality, and the second code stream quality is lower than the first code stream quality.

Optionally, the plurality of third requests include a plurality of first requests for requesting the same media data, and the media server is configured to select the plurality of first requests from the plurality of third requests, where the media data targeted by the plurality of first requests is the same; and the media server is configured to take any one of the plurality of first requests as the second request.

Optionally, the media server is configured to take the first request as the second request, if a request frequency of the plurality of third requests is less than a frequency threshold; and filter out third requests other than the first request from the plurality of third requests, and take the first request as the second request, if the request frequency of the plurality of third requests is greater than or equal to the frequency threshold.

Optionally, the media server is configured to determine code stream requirement information according to the first request, where the code stream requirement information is configured to indicate resolution information of the media data requested by the first terminal; the media server is configured to compare the code stream requirement information with a plurality of pieces of code stream actual information respectively to obtain a plurality of comparison results; where the plurality of pieces of code stream actual information represent a plurality of pieces of code stream actual information in a plurality of first media streams used by the media server to respond to the first request, and the code stream actual information is configured to indicate resolution information of media data in the first media streams; the media server is configured to select the second media stream from the plurality of first media streams according to the plurality of comparison results; and the media server is configured to transmit a third media data message including the second media stream to the first terminal.

Optionally, the media server is configured to take the first media stream corresponding to target code stream information as the second media stream, if the plurality of comparison results include that the code stream requirement information is the same as the target code stream information; where the target code stream information is one of the plurality of pieces of code stream actual information in the plurality of first media streams.

Optionally, the media server is configured to update the code stream requirement information to code stream downgrade information, if all of the plurality of comparison results indicate that the code stream requirement information is different from target code stream information; where the code stream downgrade information is configured to indicate the code stream requirement information after the resolution is lowered, and the target code stream information is one of the plurality of pieces of code stream actual information in the plurality of first media streams; and the media server is configured to match the code stream downgrade information with the plurality of pieces of code stream actual information in the plurality of first media streams, and select the first media stream corresponding to the code stream actual information that matches the code stream downgrade information as the second media stream, if the matching is successful.

Optionally, the media server is configured to transmit a fourth request to the second terminal, if the code stream downgrade information fails to match with any one of the plurality of pieces of code stream actual information in the plurality of first media streams, where the fourth request is configured to notify the second terminal to publish new media data with a preset resolution for responding to the first request.

Optionally, the media server is configured to receive the first request for media data from the first terminal based on a peer-to-peer data channel of web real-time communication.

Optionally, the first terminal is a media data subscriber, and the second terminal is a media data publisher.

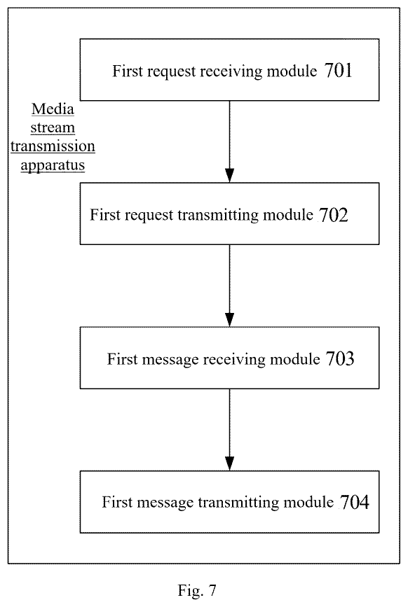

As shown in FIG. 7, based on the same inventive technical concept as the media stream transmission method provided in one or more embodiments of the present disclosure, the embodiment of the present disclosure can also provide a media stream transmission apparatus.

The media stream transmission apparatus in this embodiment is implemented on the media server in the form of software, hardware, or a combination of software and hardware. The media stream transmission apparatus may include, but is not limited to, a first request receiving module 701, a first request transmitting module 702, a first message receiving module 703, and a first message transmitting module 704. The specific description is as follows.

The first request receiving module 701 is configured to receive a first request for media data from a first terminal.

The first request transmitting module 702 is configured to determine a second request according to the downlink information and transmit the second request to a second terminal; where the downlink information is configured to indicate request load information and/or downlink network quality-of-service information, the request load information represents a quantity and/or frequency of a plurality of third requests received within a preset time period, and the plurality of third requests include the first request.

The first message receiving module 703 is configured to receive, from the second terminal, a first media data message being a response to the second request; where the first media data message includes a first media stream.

The first message transmitting module 704 is configured to transmit, to the first terminal, a second media data message being a response to the first request, where the second media data message includes a second media stream, and the first media stream includes the second media stream.

Optionally, the first request transmitting module 702 is configured to update the first request to the second request or determine the second request based on the plurality of third requests, according to the downlink information.

Optionally, the downlink network quality-of-service information includes a quality-of-service value. The first request transmitting module 702 is configured to update a first code stream quality in the first request to a second code stream quality to obtain a second request, if the quality-of-service value is less than a quality-of-service threshold; where the second request includes the second code stream quality, and the second code stream quality is lower than the first code stream quality.

Optionally, the plurality of third requests include a plurality of first requests for requesting the same media data. The first request transmitting module 702 is configured to select the plurality of first requests from the plurality of third requests, where the media data targeted by the plurality of first requests is the same; and the first request transmitting module 702 is configured to take any one of the plurality of first requests as the second request.

Optionally, the first request transmitting module 702 is configured to take the first request as the second request, if a request frequency of the plurality of third requests is less than a frequency threshold; and the first request transmitting module 702 is configured to filter out third requests other than the first request from the plurality of third requests, and take the first request as the second request, if the request frequency of the plurality of third requests is greater than or equal to the frequency threshold.

Optionally, the first message transmitting module 704 is configured to determine code stream requirement information according to the first request, where the code stream requirement information is configured to indicate resolution information of the media data requested by the first terminal; the first message transmitting module 704 is configured to compare the code stream requirement information with a plurality of pieces of code stream actual information respectively to obtain a plurality of comparison results; where the plurality of pieces of code stream actual information represent a plurality of pieces of code stream actual information in a plurality of first media streams used by the media server to respond to the first request, and the code stream actual information is configured to indicate resolution information of media data in the first media streams; the first message transmitting module 704 is configured to select the second media stream from the plurality of first media streams according to the plurality of comparison results, and transmit a third media data message including the second media stream to the first terminal.

Optionally, the first message transmitting module 704 is configured to take the first media stream corresponding to target code stream information as the second media stream, if the plurality of comparison results include that the code stream requirement information is the same as the target code stream information; where the target code stream information is one of the plurality of pieces of code stream actual information in the plurality of first media streams.

Optionally, the first message transmitting module 704 is configured to update the code stream requirement information to code stream downgrade information, if all of the plurality of comparison results indicate that the code stream requirement information is different from target code stream information; where the code stream downgrade information is configured to indicate the code stream requirement information after the resolution is lowered, and the target code stream information is one of the plurality of pieces of code stream actual information in the plurality of first media streams; and the first message transmitting module 704 is configured to match the code stream downgrade information with the plurality of pieces of code stream actual information in the plurality of first media streams, and select the first media stream corresponding to the code stream actual information that matches the code stream downgrade information as the second media stream, if the matching is successful.

Optionally, the first message transmitting module 704 is configured to transmit a fourth request to the second terminal, if the code stream downgrade information fails to match with any one of the plurality of pieces of code stream actual information in the plurality of first media streams, where the fourth request is configured to notify the second terminal to publish new media data with a preset resolution for responding to the first request.

Optionally, the first request receiving module 701 is configured to receive the first request for media data from the first terminal based on a peer-to-peer data channel of web real-time communication.

Optionally, the first terminal is a media data subscriber, and the second terminal is a media data publisher.

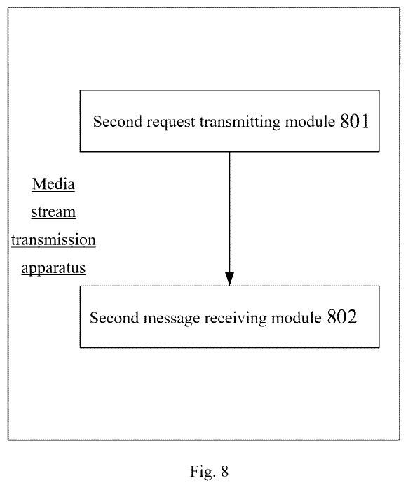

As shown in FIG. 8, based on the same inventive technical concept as the media stream transmission method provided in one or more embodiments of the present disclosure, the embodiment of the present disclosure can also provide a media stream transmission apparatus.

The media stream transmission apparatus in this embodiment is implemented on the first terminal in the form of software, hardware, or a combination of software and hardware. The media stream transmission apparatus includes, but is not limited to, a second request transmitting module 801 and a second message receiving module 802.

The second request transmitting module 801 is configured to transmit a first request for media data to a media server; where the media server is configured to determine a second request according to downlink information and to transmit the second request to a second terminal; the downlink information is configured to indicate request load information and/or downlink network quality-of-service information, the request load information represents a quantity and/or frequency of a plurality of third requests received within a preset time period, and the plurality of third requests include the first request; the media server is configured to receive, from the second terminal, a first media data message being a response to the second request; and the first media data message includes a first media stream.

The second message receiving module 802 is configured to receive, from the media server, a second media data message being a response to the first request, where the second media data message includes a second media stream, and the first media stream includes the second media stream.

Optionally, the media server is configured to update the first request to the second request or determine the second request based on the plurality of third requests, according to the downlink information.

Optionally, the downlink network quality-of-service information includes a quality-of-service value; the media server is configured to update a first code stream quality in the first request to a second code stream quality to obtain a second request, if the quality-of-service value is less than a quality-of-service threshold; where the second request includes the second code stream quality, and the second code stream quality is lower than the first code stream quality.

Optionally, the plurality of third requests include a plurality of first requests for requesting the same media data, and the media server is configured to select the plurality of first requests from the plurality of third requests, where the media data targeted by the plurality of first requests is the same; and the media server is configured to take any one of the plurality of first requests as the second request.

Optionally, the media server is configured to take the first request as the second request, if a request frequency of the plurality of third requests is less than a frequency threshold; and the media server is configured to filter out third requests other than the first request from the plurality of third requests, and take the first request as the second request, if the request frequency of the plurality of third requests is greater than or equal to the frequency threshold.

Optionally, the media server is configured to determine code stream requirement information according to the first request, where the code stream requirement information is configured to indicate resolution information of the media data requested by the first terminal; the media server is configured to compare the code stream requirement information with a plurality of pieces of code stream actual information respectively to obtain a plurality of comparison results; where the plurality of pieces of code stream actual information represent a plurality of pieces of code stream actual information in a plurality of first media streams used by the media server to respond to the first request, and the code stream actual information is configured to indicate resolution information of media data in the first media streams; the media server is configured to select the second media stream from the plurality of first media streams according to the plurality of comparison results; and the media server is configured to transmit a third media data message including the second media stream to the first terminal.

Optionally, the media server is configured to take the first media stream corresponding to target code stream information as the second media stream, if the plurality of comparison results include that the code stream requirement information is the same as the target code stream information; where the target code stream information is one of the plurality of pieces of code stream actual information in the plurality of first media streams.

Optionally, the media server is configured to update the code stream requirement information to code stream downgrade information, if all of the plurality of comparison results indicate that the code stream requirement information is different from target code stream information; where the code stream downgrade information is configured to indicate the code stream requirement information after the resolution is lowered, and the target code stream information is one of the plurality of pieces of code stream actual information in the plurality of first media streams; and the media server is configured to match the code stream downgrade information with the plurality of pieces of code stream actual information in the plurality of first media streams, and select the first media stream corresponding to the code stream actual information that matches the code stream downgrade information as the second media stream, if the matching is successful.

Optionally, the media server is configured to transmit a fourth request to the second terminal, if the code stream downgrade information fails to match with any one of the plurality of pieces of code stream actual information in the plurality of first media streams, where the fourth request is configured to notify the second terminal to publish new media data with a preset resolution for responding to the first request.

Optionally, the media server is configured to receive the first request for media data from the first terminal based on a peer-to-peer data channel of web real-time communication.

Optionally, the first terminal is a media data subscriber, and the second terminal is a media data publisher.

Based on the same inventive technical concept as the media stream transmission method provided in one or more embodiments of the present disclosure, the embodiment of the present disclosure can also provide a media stream transmission apparatus.

The media stream transmission apparatus in this embodiment is implemented on the second terminal in the form of software, hardware, or a combination of software and hardware. The media stream transmission apparatus includes, but is not limited to, a second request receiving module 901 and a second message transmitting module 902.

The second request receiving module 901 is configured to receive a second request from a media server, where the media server is configured to receive a first request for media data from a first terminal and to determine the second request according to downlink information, the downlink information is configured to indicate request load information and/or downlink network quality-of-service information, the request load information represents a quantity and/or frequency of a plurality of third requests received within a preset time period, and the plurality of third requests include the first request.

The second message transmitting module 902 is configured to transmit, to the media server, a first media data message being a response to the second request; where the first media data message includes a first media stream, the media server is configured to transmit, to the first terminal, a second media data message being a response to the first request, the second media data message includes a second media stream, and the first media stream includes the second media stream.

Optionally, the media server is configured to update the first request to the second request or determine the second request based on the plurality of third requests, according to the downlink information.

Optionally, the downlink network quality-of-service information includes a quality-of-service value; the media server is configured to update a first code stream quality in the first request to a second code stream quality to obtain a second request, if the quality-of-service value is less than a quality-of-service threshold; where the second request includes the second code stream quality, and the second code stream quality is lower than the first code stream quality.

Optionally, the plurality of third requests include a plurality of first requests for requesting the same media data, and the media server is configured to select the plurality of first requests from the plurality of third requests, where the media data targeted by the plurality of first requests is the same; and the media server is configured to take any one of the plurality of first requests as the second request.

Optionally, the media server is configured to take the first request as the second request, if a request frequency of the plurality of third requests is less than a frequency threshold; and the media server is configured to filter out third requests other than the first request from the plurality of third requests, and take the first request as the second request, if the request frequency of the plurality of third requests is greater than or equal to the frequency threshold.

Optionally, the media server is configured to determine code stream requirement information according to the first request, where the code stream requirement information is configured to indicate resolution information of the media data requested by the first terminal; the media server is configured to compare the code stream requirement information with a plurality of pieces of code stream actual information respectively to obtain a plurality of comparison results; where the plurality of pieces of code stream actual information represent a plurality of pieces of code stream actual information in a plurality of first media streams used by the media server to respond to the first request, and the code stream actual information is configured to indicate resolution information of media data in the first media streams; the media server is configured to select the second media stream from the plurality of first media streams according to the plurality of comparison results; and the media server is configured to transmit a third media data message including the second media stream to the first terminal.

Optionally, the media server is configured to take the first media stream corresponding to target code stream information as the second media stream, if the plurality of comparison results include that the code stream requirement information is the same as the target code stream information; where the target code stream information is one of the plurality of pieces of code stream actual information in the plurality of first media streams.

Optionally, the media server is configured to update the code stream requirement information to code stream downgrade information, if all of the plurality of comparison results indicate that the code stream requirement information is different from target code stream information; where the code stream downgrade information is configured to indicate the code stream requirement information after the resolution is lowered, and the target code stream information is one of the plurality of pieces of code stream actual information in the plurality of first media streams; and the media server is configured to match the code stream downgrade information with the plurality of pieces of code stream actual information in the plurality of first media streams, and select the first media stream corresponding to the code stream actual information that matches the code stream downgrade information as the second media stream, if the matching is successful.

Optionally, the media server is configured to transmit a fourth request to the second terminal, if the code stream downgrade information fails to match with any one of the plurality of pieces of code stream actual information in the plurality of first media streams, where the fourth request is configured to notify the second terminal to publish new media data with a preset resolution for responding to the first request.

Optionally, the media server is configured to receive the first request for media data from the first terminal based on a peer-to-peer data channel of web real-time communication.

Optionally, the first terminal is a media data subscriber, and the second terminal is a media data publisher.

As shown in FIG. 10, based on the same inventive technical concept as the media stream transmission method provided in the embodiment of the present disclosure, the embodiment of the present disclosure can also provide an electronic device, which includes a memory and a processor. Computer-readable instructions are stored in the memory, and the computer-readable instructions, when being executed by the processor, cause the processor to perform the media stream transmission method in any embodiment of the present disclosure. The detailed implementation process of the media stream transmission method has been described in detail in this specification, and will not be repeated here.

As shown in FIG. 10, based on the same inventive technical concept as the media stream transmission method provided in the embodiment of the present disclosure, one or more embodiments of the present disclosure can also provide an electronic device. The electronic device may include, but is not limited to, a memory and a processor. Computer-readable instructions are stored in the memory, and the computer-readable instructions, when being executed by the processor, cause the processor to perform the media stream transmission method in one or more embodiments of the present disclosure. It should be understood that the electronic device in at least one embodiment of the present disclosure may include the media stream data transmission apparatus in the embodiment of the present disclosure.

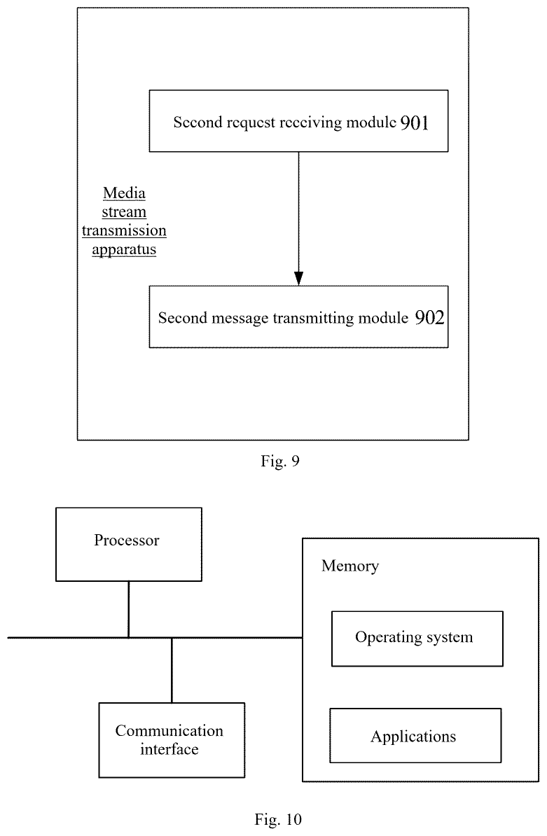

As shown in FIG. 10, the electronic device in the embodiment of the present disclosure may include: at least one processor, for example, a Central Processing Unit (CPU), etc., at least one communication interface, a memory, and at least one communication bus. The communication bus is configured to enable connection and communication among these components. The communication interface may include a display and a keyboard, and optionally, the communication interface may further include a standard wired interface and/or a wireless interface. The memory may be a high-speed volatile random access memory (RAM), or a non-volatile memory (NVM), such as at least one disk storage. Optionally, the memory may also be at least one storage device located away from the aforementioned processor. The processor may also be combined with the media stream data transmission apparatus described in any one of FIGS. 7 to 9. An application program is stored in the memory, and the processor can call the program code stored in the memory to execute any of the above method steps. The communication bus may be a Peripheral Component Interconnect (PCI) bus or an Extended Industry Standard Architecture (EISA) bus, etc. The communication bus can be divided into an address bus, a data bus, a control bus, etc. For the convenience of representation, a thick line is used in FIG. 10, but it does not mean that there is only one bus or one type of bus. The memory may include a volatile memory, such as a Random-Access Memory (RAM); the memory may also include a non-volatile memory (NVM), such as a Flash Memory, a Hard Disk Drive (HDD), or a Solid-State Drive (SSD); the memory may also include a combination of the above multiple types of memories. The processor may be a Central Processing Unit (CPU), a Network Processor (NP), or a combination of a CPU and an NP. The processor may further include a hardware chip. The above hardware chip may be an Application-Specific Integrated Circuit (ASIC), a Programmable Logic Device (PLD), or a combination thereof. The above PLD may be a Complex Programmable Logic Device (CPLD), a Field-Programmable Gate Array (FPGA), and a Generic Array Logic (GAL), or any combination thereof. Optionally, the memory is also configured to store program instructions. The processor can call the program instructions to implement the media stream transmission method as shown in any embodiment of the present disclosure.

Based on the same inventive technical concept as the media stream transmission method provided in at least one embodiment of the present disclosure, one or more embodiments of the present disclosure can also provide a storage medium storing computer-readable instructions. The computer-readable instructions, when being executed by one or more processors, cause the one or more processors to perform the media stream transmission method in any embodiment of the present disclosure. The storage medium in this embodiment may be a magnetic disk, an optical disk, a Read-Only Memory (ROM), a Random Access Memory (RAM), a Flash Memory, a Hard Disk Drive (HDD), or a Solid-State Drive (SSD), etc., and the storage medium may also include a combination of the above types of memories.

The logic and/or steps represented in the flowcharts or described herein in other ways, for example, can be regarded as a defined sequence of executable instructions for implementing logical functions, and can be specifically implemented in any computer-readable storage medium for use by an instruction execution system, device, or equipment (such as a computer-based system, a system including a processor, or other systems that can fetch and execute instructions from the instruction execution system, device, or equipment), or used in conjunction with these instruction execution systems, devices, or equipment. For the purposes of this specification, a “computer-readable storage medium” can be any device that can contain, store, communicate, propagate, or transport a program for use by an instruction execution system, device, or equipment, or in conjunction with these instruction execution systems, devices, or equipment. More specific examples (a non-exhaustive list) of computer-readable storage media include the following: an electrical connection with one or more wires (electronic device), a portable computer diskette (magnetic device), a Random Access Memory (RAM), a Read-Only Memory (ROM), an Erasable Programmable Read-Only Memory (EPROM, or Flash Memory), an optical fiber device, and a Compact Disc Read-Only Memory (CD-ROM). Additionally, the computer-readable storage medium can even be paper or other suitable medium on which the program can be printed, because the program can be obtained electronically, for example, by optically scanning the paper or other medium, followed by editing, interpretation, or processing in other suitable ways if necessary, and then storing it in a computer memory.

It should be understood that various parts of the present disclosure can be implemented by hardware, software, firmware, or a combination thereof. In the above embodiments, multiple steps or methods can be implemented by software or firmware stored in a memory and executed by a suitable instruction execution system. For example, if implemented by hardware, as in another embodiment, it can be implemented by any one of the following techniques known in the art or a combination thereof: discrete logic circuits with logic gate circuits for implementing logical functions on data signals, an application-specific integrated circuit with suitable combinational logic gate circuits, a Programmable Gate Array (PGA), a Field Programmable Gate Array (FPGA), etc.

In the description of this specification, descriptions referring to the terms “this embodiment”, “one embodiment”, “some embodiments”, “examples”, “specific examples”, or “some examples”, etc., mean that specific features, structures, materials, or characteristics described in conjunction with the embodiment or example are included in at least one embodiment or example of the present disclosure. In this specification, schematic representations of the above terms are not necessarily directed to the same embodiment or example. Moreover, the described specific features, structures, materials, or characteristics can be combined in a suitable manner in any one or more embodiments or examples. In addition, those skilled in the art can combine and integrate different embodiments or examples described in this specification, as well as the features of different embodiments or examples, without conflict.

Furthermore, the terms “first” and “second” are only used for descriptive purposes and should not be construed as indicating or implying relative importance or implicitly specifying the quantity of the indicated technical features. Thus, features defined with “first” and “second” can explicitly or implicitly include at least one of such features. In the description of the present disclosure, the meaning of “multiple” is at least two, such as two, three, etc., unless specifically and clearly defined otherwise.

The above are only the preferred embodiments of the present disclosure and are not intended to limit the present disclosure. Any modifications, equivalent replacements, and simple improvements made to the essential content of the present disclosure should all be included within the scope of protection of the present disclosure.

The above are only the preferred embodiments of the present disclosure and are not intended to limit the present disclosure. Any modifications, equivalent replacements, and simple improvements made to the essential content of the present disclosure should all be included within the scope of protection of the present disclosure.

1. A media stream transmission method, wherein the method is applied to a media server, and the method comprises:
receiving a first request for media data from a first terminal;
determining a second request according to downlink information and transmitting the second request to a second terminal; wherein the downlink information is configured to indicate request load information and/or downlink network quality-of-service information, the request load information comprises a quantity and/or frequency of a plurality of third requests received within a preset time period, and the plurality of third requests comprise the first request;
receiving, from the second terminal, a first media data message being a response to the second request; wherein the first media data message comprises a first media stream; and
transmitting, to the first terminal, a second media data message being a response to the first request, wherein the second media data message comprises a second media stream, and the first media stream comprises the second media stream.

2. The media stream transmission method according to claim 1, wherein the determining the second request according to the downlink information comprises:
updating the first request to the second request or determining the second request based on the plurality of third requests, according to the downlink information.

3. The media stream transmission method according to claim 2, wherein the downlink network quality-of-service information comprises a quality-of-service value; and the updating the first request to the second request comprises:
updating a first code stream quality in the first request to a second code stream quality to obtain a second request, if the quality-of-service value is less than a quality-of-service threshold; wherein the second request comprises the second code stream quality, and the second code stream quality is lower than the first code stream quality.

4. The media stream transmission method according to claim 2, wherein the plurality of third requests comprise a plurality of first requests for requesting the same media data, and the determining the second request based on the plurality of third requests comprises:
selecting the plurality of first requests from the plurality of third requests, wherein the media data targeted by the plurality of first requests is the same; and
taking any one of the plurality of first requests as the second request.

5. The media stream transmission method according to claim 2, wherein the determining the second request based on the plurality of third requests comprises:
taking the first request as the second request, if a request frequency of the plurality of third requests is less than a frequency threshold; and
filtering out third requests other than the first request from the plurality of third requests, and taking the first request as the second request, if the request frequency of the plurality of third requests is greater than or equal to the frequency threshold.

6. The media stream transmission method according to claim 1, wherein the transmitting the second media data message to the first terminal comprises:
determining code stream requirement information according to the first request, wherein the code stream requirement information is configured to indicate resolution information of the media data requested by the first terminal;
comparing the code stream requirement information with a plurality of pieces of code stream actual information respectively to obtain a plurality of comparison results; wherein the plurality of pieces of code stream actual information comprise a plurality of pieces of code stream actual information in a plurality of first media streams used by the media server to respond to the first request, and the code stream actual information is configured to indicate resolution information of media data in the first media streams;
selecting the second media stream from the plurality of first media streams according to the plurality of comparison results; and
transmitting a third media data message including the second media stream to the first terminal.

7. The media stream transmission method according to claim 6, wherein the selecting the second media stream from the plurality of first media streams according to the plurality of comparison results comprises:
taking the first media stream corresponding to target code stream information as the second media stream, if the plurality of comparison results comprise that the code stream requirement information is the same as the target code stream information; wherein the target code stream information is one of the plurality of pieces of code stream actual information in the plurality of first media streams.

8. The media stream transmission method according to claim 6, wherein the selecting the second media stream from the plurality of first media streams according to the plurality of comparison results comprises:
updating the code stream requirement information to code stream downgrade information, if all of the plurality of comparison results indicate that the code stream requirement information is different from target code stream information; wherein the code stream downgrade information is configured to indicate the code stream requirement information after the resolution is lowered, and the target code stream information is one of the plurality of pieces of code stream actual information in the plurality of first media streams; and
matching the code stream downgrade information with the plurality of pieces of code stream actual information in the plurality of first media streams, and selecting the first media stream corresponding to the code stream actual information that matches the code stream downgrade information as the second media stream, if the matching is successful.

9. The media stream transmission method according to claim 8, wherein the method further comprises:
transmitting a fourth request to the second terminal, if the code stream downgrade information fails to match with any one of the plurality of pieces of code stream actual information in the plurality of first media streams, wherein the fourth request is configured to notify the second terminal to publish new media data with a preset resolution for responding to the first request.

10. The media stream transmission method according to claim 1, wherein the receiving a first request for media data from a first terminal comprises:
receiving the first request for media data from the first terminal based on a peer-to-peer data channel of web real-time communication.

11. The media stream transmission method according to claim 1, wherein:
the first terminal is a media data subscriber; and
the second terminal is a media data publisher.

12. A media stream transmission method, wherein the method is applied to a first terminal, and the method comprises:
transmitting a first request for media data to a media server; wherein the media server is configured to determine a second request according to downlink information and to transmit the second request to a second terminal; the downlink information is configured to indicate request load information and/or downlink network quality-of-service information, the request load information comprises a quantity and/or frequency of a plurality of third requests received within a preset time period, and the plurality of third requests comprise the first request; the media server is configured to receive, from the second terminal, a first media data message being a response to the second request; and the first media data message comprises a first media stream; and
receiving, from the media server, a second media data message being a response to the first request, wherein the second media data message comprises a second media stream, and the first media stream comprises the second media stream.

13. A media stream transmission method, wherein the method is applied to a second terminal, and the method comprises:
receiving a second request from a media server, wherein the media server is configured to receive a first request for media data from a first terminal and to determine the second request according to downlink information, the downlink information is configured to indicate request load information and/or downlink network quality-of-service information, the request load information comprises a quantity and/or frequency of a plurality of third requests received within a preset time period, and the plurality of third requests comprise the first request; and
transmitting, to the media server, a first media data message being a response to the second request; wherein the first media data message comprises a first media stream, the media server is configured to transmit, to the first terminal, a second media data message being a response to the first request, the second media data message comprises a second media stream, and the first media stream comprises the second media stream.

14. An electronic device, comprising a memory and a processor, wherein computer-readable instructions are stored in the memory, and the computer-readable instructions, when being executed by the processor, cause the processor to perform the media stream transmission method according to claim 1.

15. An electronic device, comprising a memory and a processor, wherein computer-readable instructions are stored in the memory, and the computer-readable instructions, when being executed by the processor, cause the processor to perform the media stream transmission method according to claim 12.

16. An electronic device, comprising a memory and a processor, wherein computer-readable instructions are stored in the memory, and the computer-readable instructions, when being executed by the processor, cause the processor to perform the media stream transmission method according to claim 13.

17. A non-transitory storage medium storing computer-readable instructions, wherein the computer-readable instructions, when being executed by one or more processors, cause the one or more processors to perform the media stream transmission method according to claim 1.

18. A non-transitory storage medium storing computer-readable instructions, wherein the computer-readable instructions, when being executed by one or more processors, cause the one or more processors to perform the media stream transmission method according to claim 12.

19. A non-transitory storage medium storing computer-readable instructions, wherein the computer-readable instructions, when being executed by one or more processors, cause the one or more processors to perform the media stream transmission method according to claim 13.
